(19) United States
(12) Patent Application Publication
(10) Pub. No.: US 2021/0254271 A1
(43) Pub. Date: Aug. 19, 2021

(54) GENERATION OF METALS IN TEXTILES

(71) Applicant: Hewlett-Packard Development Company, L.P., Spring, TX (US)

(72) Inventors: Jarrid Wittkopf, Palo Alto, CA (US); Stephanie Zopf, San Diego, CA (US)

(73) Assignee: Hewlett-Packard Development Company, L.P., Spring, TX (US)

(21) Appl. No.: 17/054,680

(22) PCT Filed: Oct. 11, 2018
(86) PCT No.: PCT/US2018/055424

§ 371 Date: Nov. 11, 2020

(51) Int. Cl. D06M 10/06; D06P 5/00; D06P 5/24; D06P 5/20; D06P 1/00; D06M 11/83

(52) U.S. Cl. CPC D06M 10/06; D06P 5/001; D06M 11/83; D06P 5/2066; D06P 1/008; D06P 5/008

(57) ABSTRACT

In example implementations, a method to convert metal precursors in textiles is provided. The method includes applying a liquid metal precursor to a textile. Then, energy (e.g., heat and/or pressure) is applied to the textile. The metal precursor is converted into metal nanoparticles in the textile by sustaining application of the energy.

### BACKGROUND

As the size of electronics becomes smaller and smaller, electronics can be added to a larger variety of materials. For example, electronics are being added to flexible materials, textiles, and clothes. Incorporating metals into textiles can open a realm of additional textile applications.

For example, conductive traces added to textiles can be used to provide real-time body sensing functionality. For example, the clothes a user wears can measure heart rates, body temperature, and the like. Metals in textiles can also be used to control microbial activity and odor.

### BRIEF DESCRIPTION OF THE DRAWINGS

FIG. 1 is a block diagram of a metal precursor added to a textile and converted into metal nanoparticles of the present disclosure;

FIG. 2 is a block diagram of an example apparatus to generate metals in a textile of the present disclosure;

FIG. 3 is a more detailed block diagram of an example apparatus to generate metals in a textile of the present disclosure;

FIG. 4 is a more detailed block diagram of another example apparatus to generate metals in a textile of the present disclosure;

FIG. 5 is a flow chart of an example method to generate metal nanoparticles in a textile of the present disclosure; and

FIG. 6 is a block diagram of an example non-transitory computer readable storage medium storing instructions executed by a processor to generate metal nanoparticles in a textile of the present disclosure.

### DETAILED DESCRIPTION

Examples described herein provide a method and apparatus to generate metal nanoparticles in textiles. As discussed above, adding metal to textiles can provide additional functionality to clothing. For example, the metal can be formed as conductive traces that can be used for body sensing.

However, processes for incorporating conductive traces can be costly and time consuming. In addition, the processes can use harsh chemicals. Processes may use an excess of the metal particles to overcome durability challenges such as durability against washing and normal handling of the textile. Adding excess of the metal particles can add cost. In addition, adding excess of the metal particles can affect the material properties of the textile, for example, the flexibility, feeling of the material, stretchability, and the like. Processes may also use masks to control deposition of the metal particles, which can lead to waste and added costs.

Moreover, metal nanoparticles may have physical characteristics that make storage of metal nanoparticles difficult. For example, metal nanoparticles may be difficult to protect from oxidation over the lifetime of the metal nanoparticles. This can make the processing of the metal nanoparticles into conductive traces in a textile more difficult.

Examples herein provide a process that uses a metal precursor in a fluidic state. The metal precursor can be digitally “printed” onto the textile without the use of a mask to control the application of the metal precursor, or the textile can be immersed in the metal precursor. The metal precursor can then be converted into metal nanoparticles on the textile. The process can create the metal nanoparticles without generating or using harsh chemicals during processing. The metal precursor may absorb into the textile and allow the metal nanoparticles to be generated into the textiles, rather than sitting on the surface of the textile. Moreover, using the metal precursor can avoid the problem of oxidation of the metal nanoparticles described above.

The metal precursor can be generated using a variety of different apparatuses. For example, the metal precursor can be printed onto the textile directly. Heat and pressure can be applied via a press in a batch process or via a roller for a continuous process. The metal precursor can also be applied to a substrate, and the substrate can be transferred to the textile from the substrate with heat and pressure. Heat and pressure can be applied via a press in a batch process or via a roller for a continuous process. Thus, the methods and apparatus described herein generate metal nanoparticles in textiles in an efficient manner.

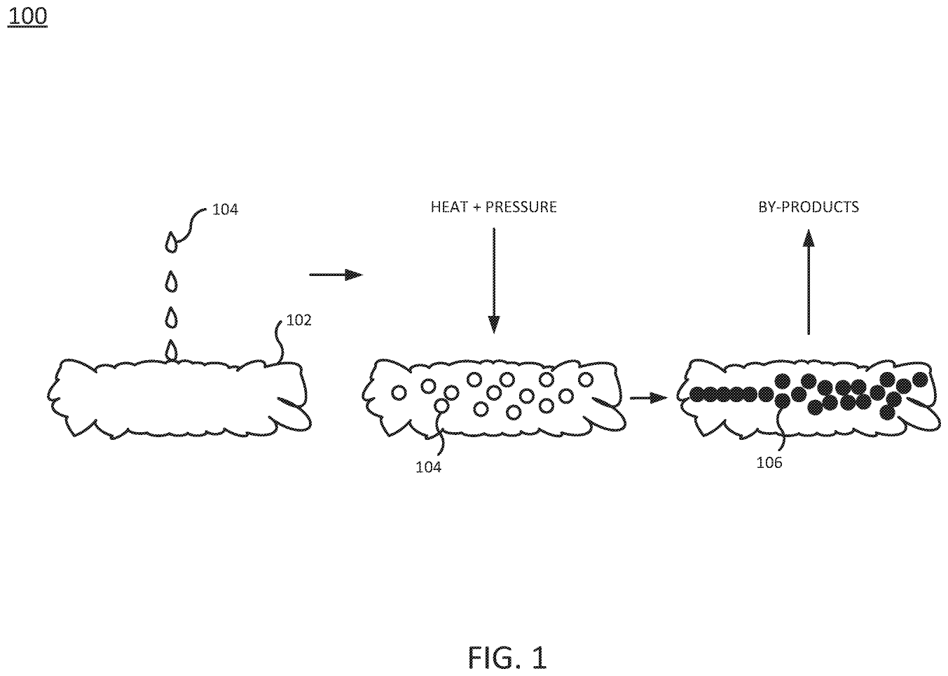

FIG. 1 illustrates a block diagram of a metal precursor added to a textile and converted into metal nanoparticles of the present disclosure. In one example, a metal precursor 104 can be applied to a textile 102. The metal precursor 104 may be in a liquid form when applied to the textile 102. The metal precursor 104 may be printed on to the textile 102, dispensed onto the textile 102, soaked onto the textile 102 (e.g., in a bath or vat of the metal precursor 104), and the like.

In one example, the textile 102 may be any type of material used to create fabrics. The textile 102 may be a natural fiber (e.g., cotton, wool, and the like) or may be a synthetic fiber (e.g., polyester, nylon, rayon, and the like). The textile 102 may be a combination of a natural fibers and synthetic fibers (e.g., a cotton and polyester blend).

The metal precursor 104 may be any type of organo-metallic salt or metallic salt. The metal can be a transition metal. Examples of the transition metal may include metals such as copper, silver, nickel, gold, platinum, cobalt, and the like. Any type of metal may be used that has a stable and soluble organic salt.

In one example, the metallic compound may have a general formula of Mₓ [Organic or Metallic Salt]_{y}, where M is the metal, x is the charge of the salt anion, and y is the oxidation sate of the metal. The organic salt or metallic salt may have polar groups such as carboxylic acid groups, amine groups, or other functional groups that can allow for dissociation in an aqueous environment. Carbon chains on the salt may be relatively short to increase solubility as well as overall metal content in the solution. Examples of organic salt anions that can be used may include formate, acetate, oleate, and the like.

In one example, energy may be applied to the textile 102 to convert the metal precursor 104 into metal nanoparticles 106. The energy may be in the form of heat and/or pressure. The metal precursor 104 in liquid form may soak into the textile 102. Thus, the metal precursor 104 may have better coverage, and possibly more uniform coverage, in the textile 102. This may allow the metal nanoparticles that are eventually formed to have better adhesion and durability in the textile 102.

In one example, the energy that is applied to convert the metal precursor 104 into the metal nanoparticles 106 may be applied by photonic means or mechanical means, as discussed in further detail below. The amount of heat and pressure that is applied may vary based on the type of metal and organic or metallic salt that is used in the metal precursor 104 and the physical properties of the textile 102. For example, some types of textiles may be able to withstand higher temperatures and pressure than other types of textiles without deforming or changing the feel or appearance of the textile.

In one example, where copper formate is the metal precursor 104, the metal precursor 104 may be heated to between 150 degrees Celsius (° C.) and 200° C. In one example, the heat may be approximately 160° C. The pressure may be approximately 10 to 20 pounds per square inch (psi). However, as noted above, the actual amount of heat and pressure may depend on the type of metal and salt that is used for the metal precursor 104.

After the heat and pressure are applied, the metal precursor 104 may be converted into metal nanoparticles 106 and by-products. In on example, the general formula for the reaction may be M^{y+}+[Organic Salt]^{x-}=>M⁰+[decomposed organic salt]. In the example of copper formate used above, the reaction may be Cu²⁺+2HCOO¹⁻=>Cu⁰₍ₛ₎⁺2CO_{2(g)}+H₂O₍ₗ₎. Notably, the by-products may be inert gases such as carbon dioxide and water as can be seen in the reaction for copper formate.

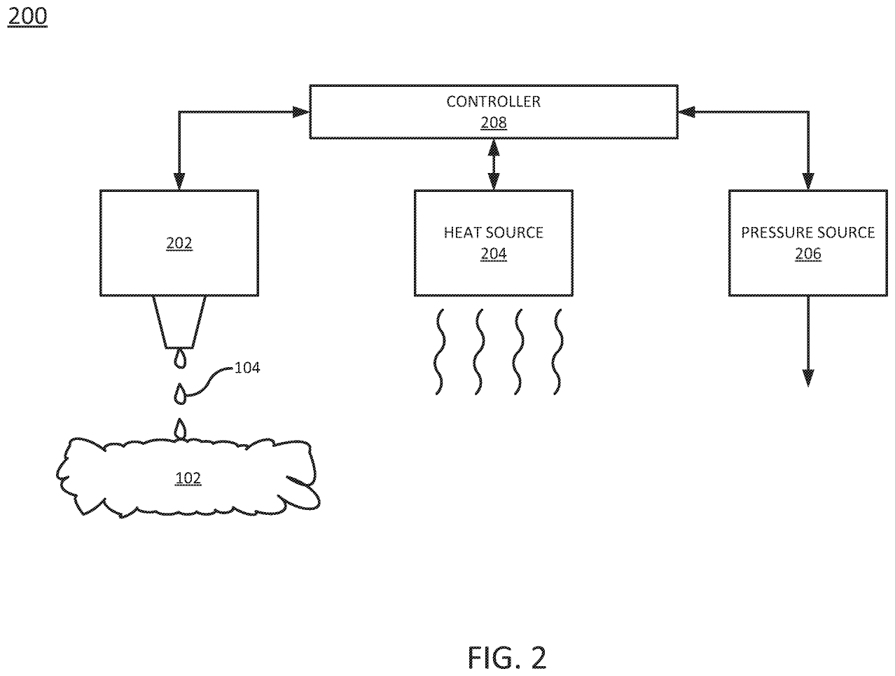

FIG. 2 illustrates a block diagram of an example apparatus 200 to generate metals in a textile of the present disclosure. In one example, the apparatus 200 may include a metal precursor dispenser 202, a heat source 204, a pressure source 206, and a controller 208. The controller 208 may be communicatively coupled to the metal precursor dispenser 202, the heat source 204, and the pressure source 206 to control operation of the dispenser 202, the heat source 204, and the pressure source 206.

In one example, the dispenser 202 may be a printhead that can be digitally controlled to dispense the metal precursor 104 in desired locations on the textile 102. For example, the desired location of metal traces can be identified and the controller 208 may control the dispenser 202 to dispense the metal precursor 104 in the corresponding locations. In one example, the printhead can be moved, the textile can be moved, or a combination of both.

In one example, the dispenser 202 may be a bath or vat, as noted above. In other words, the textile 102 may be dipped into a bath of the metal precursor 104 to soak the entire textile 102.

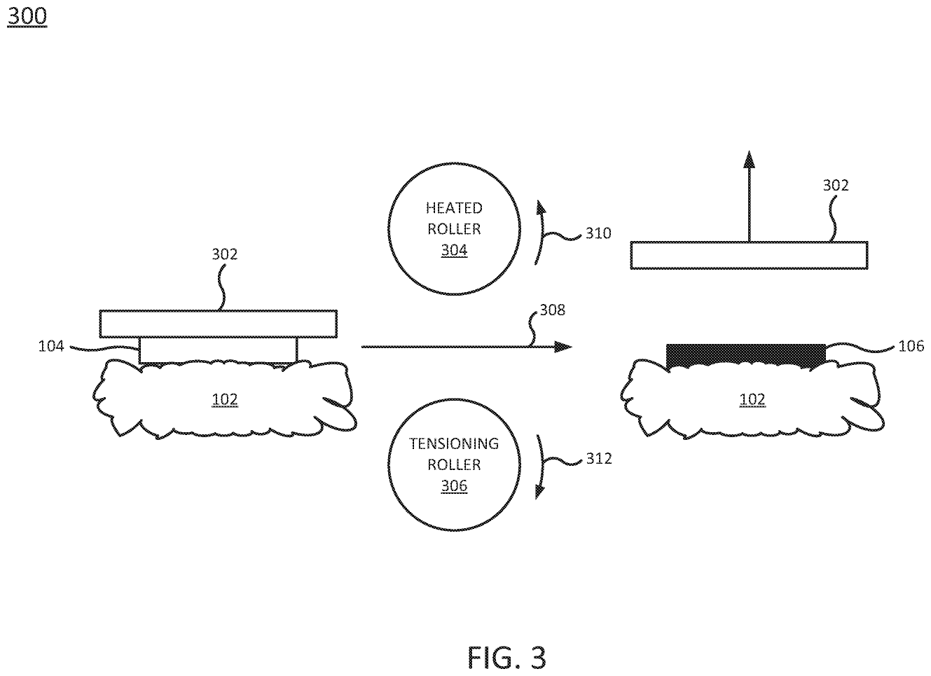

In one example, the metal precursor 104 may be printed onto a substrate. The side of the substrate with the metal precursor 104 may then be applied against a surface of the textile 102. An example is illustrated in FIG. 3 and discussed below.

The heat source 204 may apply heat to the metal precursor 104 and the pressure source 206 may apply pressure to the metal precursor 104 to convert the metal precursor 104 into the metal nanoparticles 106, as described above. Although the heat source 204 and the pressure source 206 are illustrated as separate devices, it should be noted that the heat source 204 and the pressure source 206 may be combined into a single device.

In one example, the heat source 204 may generate different forms of heat. In one example, the heat may be generated via a thermal or electrical source. For example, a platform or surface may be heated to apply the heat on to the textile 102. In another example, the heat source 204 may use light to generate heat. For example, the heat source 204 may use photosintering to apply ultraviolet, visible, or infrared light in millisecond periods to heat the metal precursor 104.

In one example, the heat source 204 and the pressure source 206 may be applied as part of a continuous process. For example, a line of textiles 102 with metal precursor 104 applied to the textiles 102 may be continuously processed (e.g., along a conveyer belt). In one example, the heat source 204 and the pressure source 206 may be applied as part of a batch process. For example, a single textile 102 with metal precursor 104 applied to the textile 102 may be processed at a time by the apparatus 200.

FIG. 3 illustrates a block diagram of an example apparatus 300 to generate metals in a textile of the present disclosure. In one example, the apparatus 300 may operate in a continuous process. In other words, a line of textiles 102 may be fed or processed by the apparatus 300 in a continuous fashion.

The apparatus 300 illustrates an example where the metal precursor 104 is applied to a substrate 302. The metal precursor 104 may be dispensed or printed onto the substrate 302 in a pattern or may cover an entire side of the substrate 302. In one example, the substrate 302 may be a polymer, plastic, or film that can carry the metal precursor 104.

In one example, a side of the substrate 302 with the metal precursor 104 may be in contact with the textile 102. In other words, the layer of the metal precursor 104 may be situated between the substrate 302 and the textile 102. In one example, the substrate 302 may be used to transfer the metal nanoparticles 106 on an exterior side of the textile 102.

In one example, the substrate 302, the metal precursor 104, and the textile 102 may be fed between a heated roller 304 and a tensioning roller 306. Although the heated roller 304 and the tensioning roller 306 appear to have the same dimensions, it should be noted that the heated roller 304 and the tensioning roller 306 may have different dimensions. For example, the diameter of the tensioning roller 306 may be changed to adjust an amount of pressure that is applied by the tensioning roller 306.

In one example, the substrate 302, the metal precursor 104, and the textile 102 may be fed in a direction as shown by an arrow 308. The heated roller 304 and the tensioning roller 306 may be spaced apart such that the heated roller 304 contacts the substrate 302 and the tensioning roller 306 applies a desired amount of pressure against the textile 102 and the metal precursor 104.

In one example, the heated roller 304 may represent the heat source 204 and the tensioning roller 306 may represent the pressure source 206 illustrated in FIG. 2. In one example, the tensioning roller 306 may also be heated to apply a desired amount of heat to the textile 102 and the metal precursor 104.

The heated roller 304 and the tensioning roller 306 may rotate in opposition directions as shown by arrows 310 and 312 in FIG. 3. The rotation of the heated roller 304 and the tensioning roller 306 may feed the textile 102 through. After the textile 102 is fed through and between the heated roller 304 and the tensioning roller 306, the substrate 302 may be removed. The heat and pressure applied by the heated roller 304 and the tensioning roller 306 may convert the metal precursor 104 into a layer of metal nanoparticles 106. The layer of metal nanoparticles 106 may form a conductive trace or barrier on the textile 102.

In one example, the textile 102 may have the metal precursor 104 printed directly into the textile 102, as described above. In other words, the metal precursor 104 may be soaked into the textile 102 such that the metal nanoparticles 106 are formed inside of the textile 102.

When the metal precursor 104 is printed directly into the textile 102, the heated roller 304 and the tension roller 306 may heat the metal precursor 104 inside of the textile 102 as the textile 102 is fed through the apparatus 300. Thus, the heat and pressure applied to the textile 102 and the metal precursor 104 may cause the metal precursor 104 to be converted into metal nanoparticles 106 inside of the textile 102 as illustrated in FIG. 1 and discussed above.

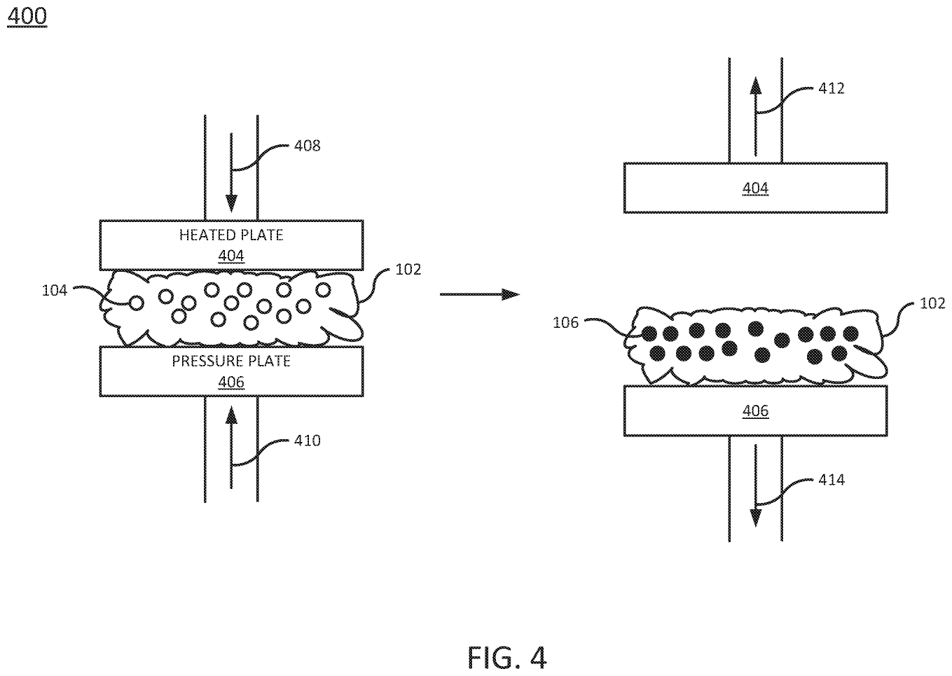

FIG. 4 illustrates a block diagram of an example apparatus 400 to generate metals in a textile of the present disclosure. In one example, the apparatus 400 may operate in a batch process. In other words, a single textile 102 may be processed at a time to convert the metal precursor 104 into metal nanoparticles 106.

The apparatus 400 may include a heated plate 404 and a pressure plate 406. The heated plate 404 may be heated to apply a desired amount of heat. The heated plate 404 may operate with internal electric coils or may be a conductive metal that is heated to a desired temperature. The pressure plate 406 may apply pressure at a desired amount by moving towards the heated plate 404 and pressing against the heated plate 404. In one example, the pressure plate 406 may also be heated.

Although the heated plate 404 and the pressure plate 406 appear to have the same size and dimensions, it should be noted that the heated plate 404 and the pressure plate 406 may have different dimensions. For example, the pressure plate 406 may have a larger surface area than the heated plate 404, the heated plate 404 may have a greater thickness than the pressure plate 406, and so forth.

In one example, the metal precursor 104 may be applied to the textile 102, as described above. The textile 102 may be placed on a pressure plate 406. The heated plate 404 and the pressure plate 406 may be moved towards each other as shown by arrows 408 and 410. The heated plate 404 may apply a desired amount of heat to the textile 102 and the metal precursor 104. The pressure plate 406 may apply a desired amount of pressure to the textile 102 and the metal precursor 104.

After desired amounts of heat and pressure are applied for a predetermined amount of time, the heated plate 404 and the pressure plate 406 may be moved away from each other as shown by arrows 412 and 414. The metal precursor 104 may be converted into metal nanoparticles 106 inside of the textile 102 as shown by FIG. 4.

Thus, the apparatuses illustrated in FIG. 2-4 may be used to convert the metal precursor 104 into metal nanoparticles 102 in a textile 102 as shown in FIG. 1. As noted above, using the metal precursor 104 in a liquid form may allow for more efficient and effective adhesion of the formed metal nanoparticles inside of the textile. In addition, the liquid metal precursor 104 may not experience oxidation during storage that may be experienced by applying metal nanoparticles directly to the textiles.

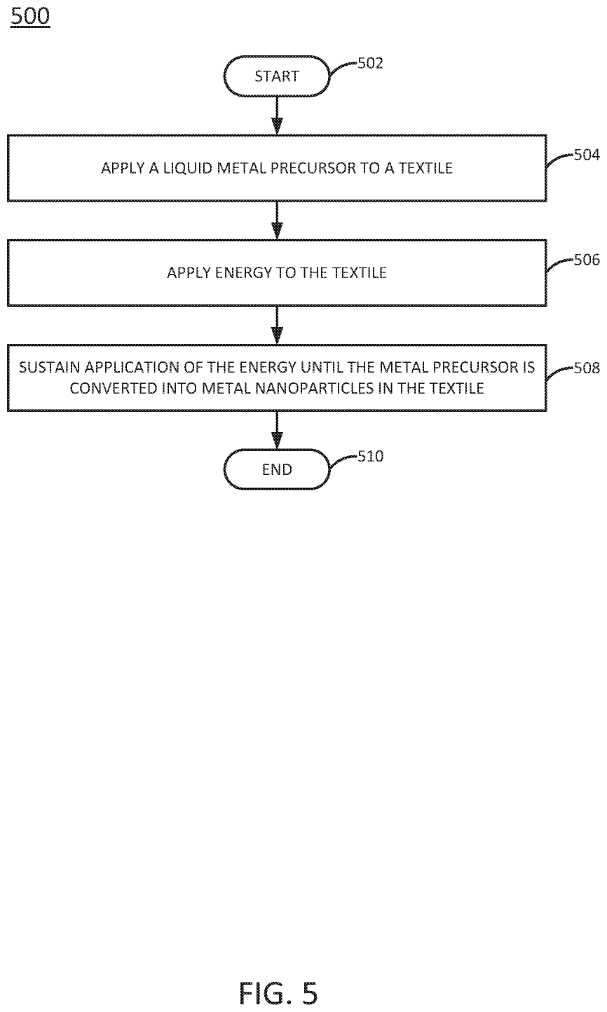

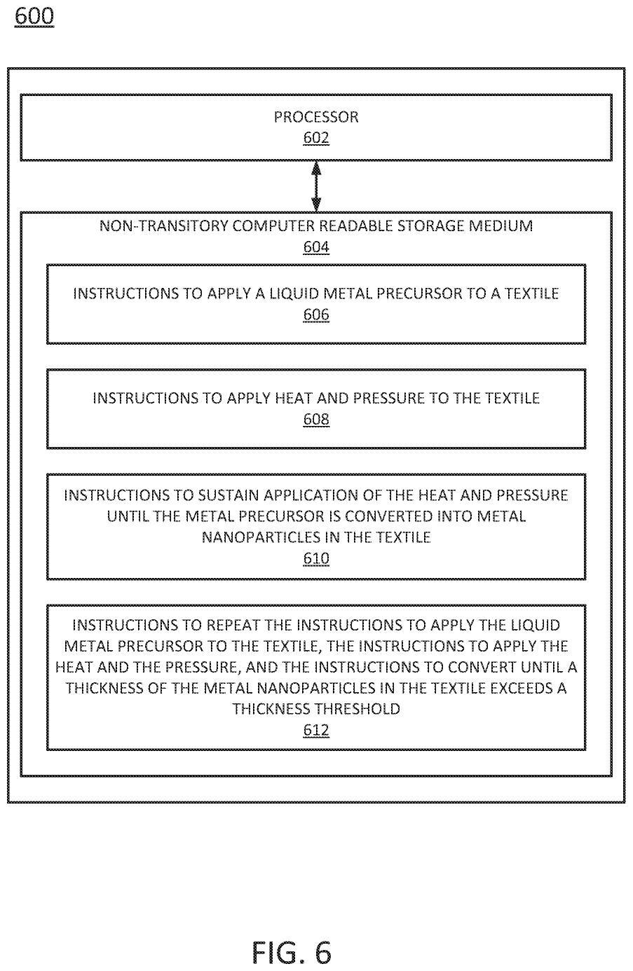

FIG. 5 illustrates a flow diagram of an example method 500 for generating metal nanoparticles in a textile. In an example, the method 500 may be performed by the apparatus 200, 300, 400, or the apparatus 600 illustrated in FIG. 6 and described below.

At block 502, the method 500 begins. At block 504, the method 500 applies a liquid metal precursor to a textile. In one example, the liquid metal precursor may be applied by a printing process through a printhead. For example, a desired pattern of the liquid metal precursor may be printed onto the textile.

In one example, the textile may be immersed in the liquid metal precursor. For example, the liquid metal precursor may be dispensed into a container or bath and the textile may be immersed in the bath to soak the entire textile in the liquid metal precursor.

In one example, an intermediate substrate may be used to apply the liquid metal precursor. For example, the metal precursor may be applied to the substrate. The substrate may then be applied to the textile, as described above. The intermediate substrate may be used when the liquid metal precursor is to be applied to a surface of the textile.

The liquid metal precursor may be a compound of a transition metal in an organo-metallic or metallic salt compound, as described above. The metal may be copper, silver, nickel, gold, platinum, cobalt, and the like. Any type of metal may be used that has a stable and soluble organic salt. The organic salt or metallic salt may have polar groups such as carboxylic acid groups, amine groups, or other functional groups that can allow for dissociation in an aqueous environment. Carbon chains on the salt may be relatively short to increase solubility as well as overall metal content in the solution. Examples of organic salt anions that can be used may include formate, acetate, oleate, and the like.

At block 506, the method 500 applies energy to the textile. The energy may be heat and/or pressure that is applied mechanically or via a photosintering process. For example, the heat may be applied using a heated roller or plate or a light source that emits ultraviolet rays, visible, or infrared light. The pressure may be applied mechanically by using mechanical rollers or a plate to press against the metal precursor and the textile.

The amount of heat and pressure that are applied may be a function of the metal that is used, stability of the metal salt, and the physical properties of the textile. For example, textiles that are heat resistant may use high amounts of heat. Some metal salts may convert into metal nanoparticles at lower temperatures. As noted above, in the example using copper formate, the textile may be heated to approximately 160° C. at 10-20 psi.

The heat and pressure may be applied for a predetermined time period. The predetermined time period may vary based on the metal that is used and the heating method. For example, using a heated roller on copper formate, the heat and pressure may be applied for a few seconds. However, using a photosintering method, the heat may be applied for a few milliseconds to convert the metal precursor into the metal nanoparticles.

At block 508, the method 500 sustains application of the energy until the metal precursor is converted into metal nanoparticles in the textile. For example, the metal may react to the heat and pressure to form the metal nanoparticles and harmless by products. Using the example of copper formate, the heat and pressure may convert the copper formate into metal copper, carbon dioxide gas, and water. At block 510, the method 500 ends.

FIG. 6 illustrates an example of an apparatus 600. In one example, the apparatus 600 may be the apparatus 200, 300, or 400. In one example, the apparatus 600 may include a processor 602 and a non-transitory computer readable storage medium 604. The non-transitory computer readable storage medium 604 may include instructions 606, 608, 610, and 612 that, when executed by the processor 602, cause the processor 602 to perform various functions to generate metal nanoparticles in textiles.

In one example, the instructions 606 may include instructions to apply a liquid metal precursor to a textile. The instructions 608 may include instructions to apply heat and pressure to the textile. The instructions 610 may include instructions to sustain application of the heat and pressure until the metal precursor is converted into metal nanoparticles in the textile. The instructions 612 may include instructions to repeat the instructions to apply the liquid metal precursor to the textile, the instructions to apply the heat and the pressure, and the instructions to convert until a thickness of the metal nanoparticles in the textile exceeds a thickness threshold.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
applying a liquid metal precursor to a textile;
applying energy to the textile; and
sustaining application of the energy until the metal precursor is converted into metal nanoparticles in the textile.

2. The method of claim 1, wherein the applying the liquid metal precursor comprises:
printing the metal precursor onto select areas of the textile.

3. The method of claim 1, wherein the applying the liquid metal precursor comprises:
immersing the textile in the metal precursor.

4. The method of claim 1, wherein the applying the liquid metal precursor comprises:
coating a substrate with the liquid metal precursor; and
applying the substrate to the textile such that the liquid metal precursor contacts the textile.

5. The method of claim 1, wherein the energy that is applied comprises heat, and the heat is applied mechanically or via a photosintering process.

6. The method of claim 1, wherein the metal precursor comprises an organo-metallic salt or a metallic salt.

7. The method of claim 1, wherein the liquid metal precursor is selected based on a temperature to convert the liquid metal precursor into the metal nanoparticles and physical properties of the textiles.

8. An apparatus, comprising:
a metal precursor dispenser to dispense a metal precursor onto a textile;
a heat source to apply heat to the metal precursor on the textile;
a pressure source to apply pressure to the metal precursor, wherein the heat and the pressure that is applied is to convert the metal precursor into a metal nanoparticle in the textile; and
a controller in communication with the metal precursor dispenser and the heat source to control operation of the metal precursor dispenser and the heat source.

9. The apparatus of claim 8, wherein the heat source and the pressure source are provided by a single mechanical mechanism.

10. The apparatus of claim 8, wherein the controller is to operate the metal precursor dispenser, the heat source, and the pressure source in a continuous process.

11. The apparatus of claim 10, wherein the heat source and the pressure source comprise a pair of opposing heated rollers.

12. The apparatus of claim 8, wherein the controller is to operate the metal precursor dispenser, the heat source, and the pressure source in a batch process.

13. The apparatus of claim 12, wherein the heat source and the pressure source comprise a pair of opposing heated plates.

14. A non-transitory computer readable storage medium encoded with instructions executable by a processor, the non-transitory computer-readable storage medium comprising:
instructions to apply a liquid metal precursor to a textile;
instructions to apply heat and pressure to the textile;
instructions to sustain application of the heat and pressure until the metal precursor is converted into metal nanoparticles in the textile; and
instructions to repeat the instructions to apply the liquid metal precursor to the textile, the instructions to apply the heat and the pressure, and the instructions to convert until a thickness of the metal nanoparticles in the textile exceeds a thickness threshold.

15. The non-transitory computer readable storage medium of claim 14, wherein the liquid metal precursor comprises copper formate that is heated to between 150-200 degrees Celsius with an amount of pressure of 10-20 pounds per square inch.
